(19) United States
(12) Patent Application Publication
(10) Pub. No.: US 2025/0094607 A1
(43) Pub. Date: Mar. 20, 2025

(54) CONTROLLABLE EDGE GATEWAY RETIREMENT

(71) Applicant: Dell Products L.P., Round Rock, TX (US)

(72) Inventors: TOMER SHACHAR, Beer-Sheva (IL); MAXIM BALIN, Gan-Yavne (IL); YEVGENI GEHTMAN, Modi'in (IL)

(21) Appl. No.: 18/468,272

(22) Filed: Sep. 15, 2023

(51) Int. Cl. G06F 21/60

(52) U.S. Cl. CPC G06F 21/604

(57) ABSTRACT

Methods and systems for retiring edge devices are disclosed. The edge devices may be secured through destruction of the trusted platform module. Destruction of the trusted platform module may remove access to the key used to encrypt all data on an edge device. Removal of access to the key on an edge device may render data on the edge device to be inaccessible. Data that may be inaccessible may ultimately secure the edge device from access. In securing the access to the edge device, the edge device may be retired.

### FIELD

Embodiments disclosed herein relate generally to device management. More particularly, embodiments disclosed herein relate to retiring edge devices by destroying trusted platform modules.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams illustrating data flows and processes in accordance with an embodiment.

FIG. 3 shows a flow diagram illustrating a method of retiring edge devices in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for retiring edge devices. Retiring an edge device may include eliminating data stored in the edge devices. To eliminate the data, the data may be logically eliminated by preventing encryption/decryption keys used to encrypt data from being used in the future.

To prevent the use of the keys in the future, trusted platform modules (TPMs) that manage the keys may be destroyed. Destroying the TPM may prevent future use of the keys, thereby rendering the data of the edge device logically inaccessible even if encrypted copies of the data remain accessible.

Once retired, the edge devices may initiate confirmation of the destruction of the TPMs. Confirmation may be obtained by performing testing procedure to ensure the TPM has been destroyed. Once confirmation is obtained, a report may be generated to enumerate details of the process performed to destroy the TPM. The report may include specifications of the device, the location of the edge device anywhere in the world, and confirmation of the effectiveness of the burnout procedure.

In an embodiment, a method for retiring edge devices is provided. The method may include: (i) obtaining a request to retire an edge device of the edge devices; (ii) making a determination that a burnout procedure is to be performed as part of retiring the edge device; and (ii) based on the determination: performing the burnout procedure to eliminate use of a key by the edge device, the use of the key being required to use data stored by the edge device.

Performing the burnout procedure may include destroying a trusted platform module that is required for use of the key by the edge device.

Destroying the trusted platform module may include (i) activating an enhanced power circuit that connects a power supply to the trusted platform module and (ii) sending a voltage from the power supply to the trusted platform module via the enhanced power circuit to destroy the trusted platform module, the trusted platform module holding the key.

Performing the burnout procedure may further include sending an audit report with a set of specifications of the edge device to the edge management device, the audit report indicating a condition of the trusted platform module after the voltage is sent to the trusted platform module.

The set of specifications may include operating details for the edge device, a location of the edge device, intended results of the burnout procedure, and confirmatory results of a testing procedure which is performed after the burnout procedure and indicates an outcome of the burnout procedure.

The trusted platform module may be powered by the power supply via a second power circuit, the second power circuit sending a second voltage at a level compatible with nominal operation of the trusted platform module, and the voltage being at a higher level than the second voltage to cause the trusted platform module to be damaged by the voltage.

Activating the enhanced power circuit may include (i) activating, by a basic input-output system (BIOS) of the edge device, a power management function of a power controller of the edge device and (ii) activating, by the power controller and based on the activation by the BIOS, a circuitry initiation function of the power supply to initiate use of the enhanced power circuit.

The key may be a volume management key used to encrypt all data stored by the edge device, and the key being required to decrypt the encrypted data.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

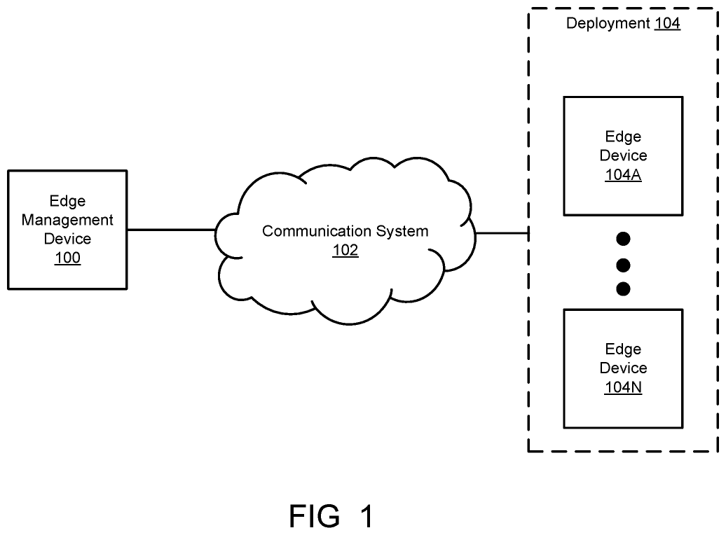

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, the system of FIG. 1 may include deployment 104. Deployment 104 may include any number of edge devices (e.g., 104A-104N) that cooperatively and/or individually provide all, or a portion, of the computer implemented services.

While the computer implemented services are provided, data used in the computer implemented services may be stored locally on the edge devices. Any of the data may include, for example, sensitive information

Overtime, any of edge devices 104A-104N may need to be replaced (e.g., due to age, errors in operation, etc.) and/or discarded for other reasons. When an edge device is to be discarded, the data stored on the edge device may not automatically become unusable. For example, the data may be stored in persistent storage such as hard disk drives, solid state storage devices, etc. Consequently, unless some action is taken to limit access to the data, the data may be accessible via these devices after the host edge device is discarded.

In general, embodiments disclosed here relate to systems and methods for retiring devices (e.g., edge devices or other types of computing device) in a manner that renders data hosted by the devices inaccessible after the retirement. In an embodiment, to retire the devices, the devices may be required to encrypt all data stored in the device using a secret (e.g., a volume management key). To use the data, the data may need to be decrypted. Consequently, access to the data may be practically impossible without the ability to decrypt the data. The secret may be maintained by a trusted platform module (TPM) of the edge device.

During retirement processes, the edge devices may destroy the TPMs that maintain the secrets usable to decrypt the stored data. Accordingly, the data may be logically destroyed in this manner by making the encrypted version of the data unable to be decrypted.

To facilitate destruction of the TPMs, the edge devices may include, for example, mechanisms that may be used to damage the TPMs. These mechanisms may include, for example, electrical circuits adapted to deploy a quantity of current that exceeds damage thresholds for the TPM. When activated, the resulting current may damage the TPMs making them unable to facilitate use of the secrets that they maintain.

To secure a device of edge device 104A-104N, authorization may be given by edge management device 100 to destroy the TPM on a device. The authorization may cause an edge device to activate a power management function in the power controller of a basic input-output system (BIOS) of the edge device. The power controller may activate an enhanced circuit in the power supply, the enhanced circuit being separate from any circuitry that may power other portions of the edge device. The enhanced circuit may send sufficient power (e.g., voltage/current of sufficient magnitude) to the TPM to destroy the operability of the TPM. For example, the current may destroy transistors of the TPM that facilitate its operation.

After the voltage is sent to the TPM from the enhanced circuit, edge management device 100 may implement a testing procedure to confirm destruction of the TPM. To confirm destruction of the TPM, edge management device 100 may invoke a function of the edge device that requires use of the TPM and secrets included therein. The edge device may attempt to perform the function based on the invocation. Depending on whether the attempt is successful or unsuccessful, the edge device may respond in different manners. Based on the type of the response, edge management device 100 may conclude whether the TPM has or has not been destroyed.

To provide the above noted functionality, the system may include edge management device 100, deployment 104, edge device 104A-104N, and communication system 102. Each of these components is discussed below.

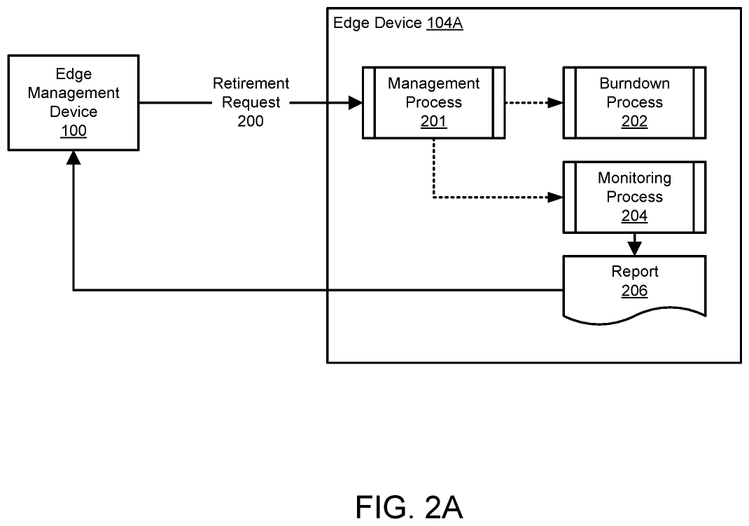

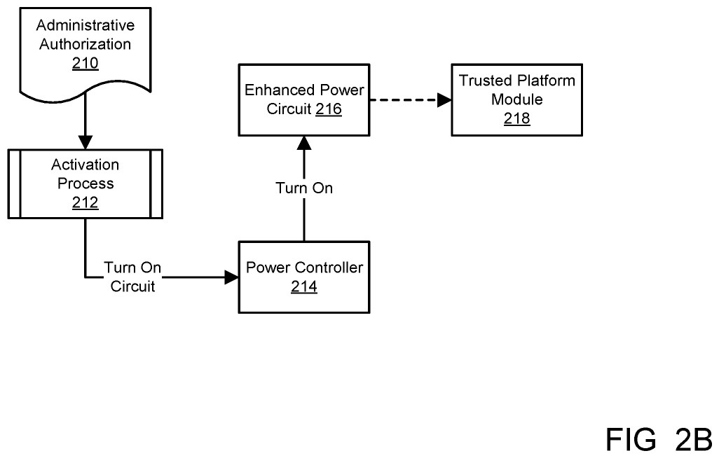

Edge management device 100 may manage edge devices 104A-104N. To manage the edge devices, edge management device 100 may initiate and verify completion of retirements of the edge devices. Refer to FIG. 2A for additional details regarding retiring edge devices.

Deployment 104 may include any number of edge devices. The edge devices of deployment 104 may cooperatively and/or individually provide any number of computer implemented services.

In addition to providing computer implemented services, edge device 104A-104N may include (i) TPMs that maintain secrets used to encrypt data used in the computer implemented services, and (ii) mechanisms to destroy the TPMs. To retire itself, an edge device may active its mechanisms to destroy its TPM. Refer to Refer to FIG. 2B on additional details regarding using a mechanism to destroy a TPM during retirement of an edge device.

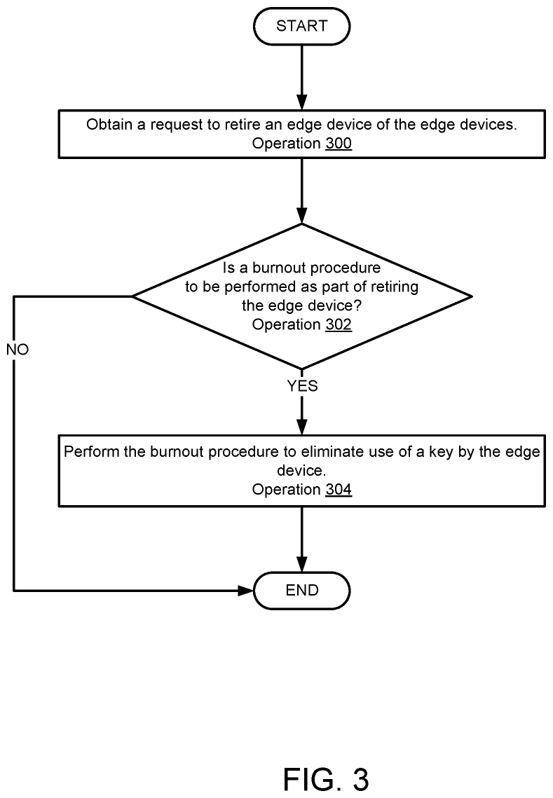

When providing their functionalities, any of (and/or components thereof) edge management device 100 and deployment 104 may perform all, or a portion, of the method shown in FIG. 3.

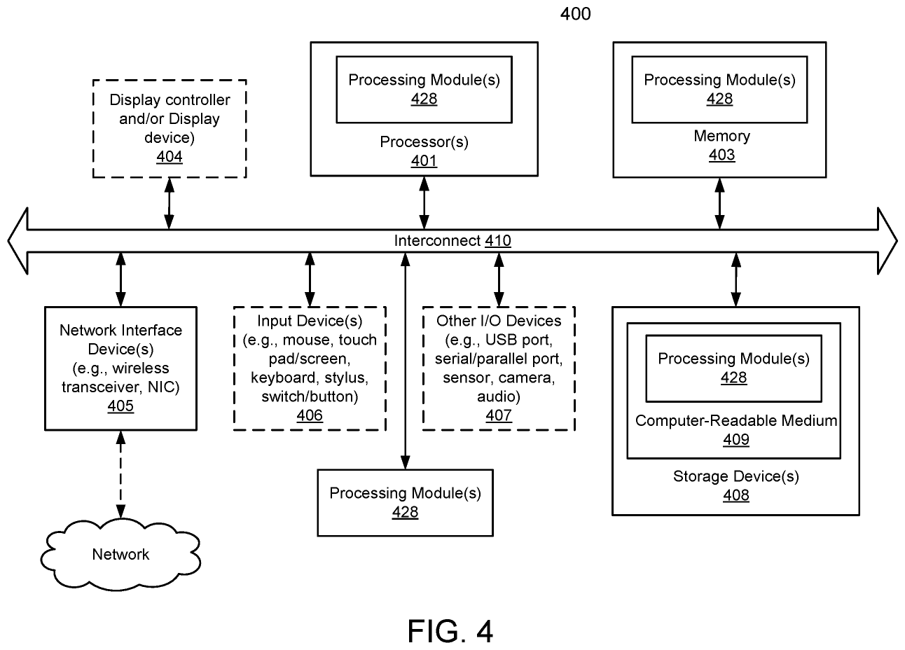

Any of (and/or components thereof) edge management device 100 and deployment 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 206, etc.) is used to represent data structures, and a second set of shapes (e.g., 201, 202, 204, etc.) is used to represent processes performed using and/or that generate data.

Turning to FIG. 2A, a first data flow diagram in accordance with an embodiment is shown. The first data flow diagram may illustrate data used in and data processing performed in retirement of an edge device.

To retire an edge device, edge management device 100 may send retirement request 200 to the edge device. Retirement request 200 may be sent, for example, when an administrator initiates retirement of the edge device.

Retirement request 200 may include instructions for performing a retirement process, and may be signed or otherwise verifiable by edge device 204A.

When obtained be edge device 104A, retirement request 200 may be ingested by management process 201. Management process 201 may be a general management process performed by edge device 104A that manages operation of edge device 104A (e.g., may correspond to activity of an operating system, specific applications, etc.). Management process 201 may verify retirement request 200 (e.g., by checking a signature of retirement request 200 using a trusted public key). If verified, management process 201 may initiate burndown process 202 and/or monitoring process 204. In FIG. 2A, the lines between management process 201 and these other processes are drawn in dashing to indicate that these processes may only be performed when retirement request 200 can be verified.

During burndown process 202, actions to destroy a TPM of edge device 104A may be performed. Refer to FIG. 2B for additional details regarding these actions.

During monitoring process 204, various actions for monitoring the performance of burndown process 202 and to ascertain an outcome of burndown process 202 may be performed. For example, functionality of the TPM may be invoked after burndown process 202 is complete to ascertain whether the TPM is inoperable. Report 206 may be generated based on the information obtained during monitoring process 204. Report 206 may include information regarding the performance of burndown process 202, and results of testing of the TPM.

Once obtained, report 206 may be provided to edge management device 100 to confirm whether the retirement of edge device 10A4 was completed nominally, or whether remedial action may be warranted such as performing burndown process 202 again, performing other procedures, etc.

For example, consider a scenario where a spy satellite is used to gather information. The spy satellite may have been developed to photograph terrain all over the Earth. Consequently, various pieces of sensitive information may be stored in the persistent storage of the spy satellite. At some point in the lifecycle of the spy satellite, the spy satellite may be considered to be obsolete and may eventually be replaced with a new spy satellite equipped with new technology.

The spy satellite may include sensitive data and photographs. Since the spy satellite is in space, much effort may be required to bring it down from orbit. Therefore, it may be cost-efficient to leave it in orbit but render access to the photographs and other sensitive data impossible. To do so, burndown process 202 may be initiated.

To confirm that access to the data has been rendered in possible by performance of the burndown procedure, a report may be generated and provided back to an operator of the spy satellite. In this example, the report may indicate that when copies of photos stored in the spy satellite are requested, the encrypted copies of the photos maintained by the spy satellite may not be able to be decrypted and, therefore, cannot be provided in response requests for them. Consequently, the operator of the spy satellite may conclude that the data has been rendered sufficiently inaccessible to meet requirement standards.

Turning to FIG. 2B, a second data flow diagram in accordance with an embodiment is shown. The second data flow diagram may illustrate data used in and data processing performed in retiring an edge device].

To retire the edge device, an administrative authorization (e.g., 210) may be extracted from retirement request 200. Administrative authorization 210 may be a data structure that indicates that the TPM of edge device 104A is to be destroyed, and may include verification data such as a cryptographically verifiable signature.

During activation process 212, administrative authorization 210 may be verified (e.g., using a public key to verify the signature, and check an identity of the signer to make sure that the signer has authority to initiate destruction of the TPM). Presuming that administrative authorization 210 can be verified, then destruction of the TPM may be initiated by sending a notification (e.g., via a BIOS command) to start functionality of power controller 214. The notification may indicate that enhanced power circuit 216 is to be powered (e.g., turned on). Upon receipt of the notification, power controller 214 (e.g., a microcontroller or other hardware device) may direct a power supply to activate enhanced power circuit 216. Enhanced power circuit 216 may connect the power supply to the TPM. Once enhanced power circuit 216 is activated, a voltage sufficient to damage the TPM may be applied to the TPM by the enhanced power circuit.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2B, embodiments disclosed herein may facilitate retirement of devices by eliminating access to data stored in the device.

While described in FIGS. 2A-2B with respect to application of electrical current to the TPM, it will be appreciated that similar approaches to eliminating data storage devices may be implemented to eliminate access to data. For example, rather than applying electrical current to the TPM, the electrical current may instead be applied to heating elements positioned near storage devices. When the electrical current is applied, the heating elements may increase the temperature of the storage devices beyond their operable range thereby destroying the storage devices. To facilitate heating, the storage devices may be positioned in an enclosure that may selectively retain or expel heat. During normal operation, vents in the enclosure may be retained in an open position. However, during retirement, the vents may be closed thereby trapping heat proximate to the storage device. With the heating elements positioned within the enclosure, the storage devices may be heated to a sufficient temperature to permanently damage them or at least cause media in which data is encoded to lose its state thereby causing the data to be lost.

Further, any of the aforementioned mechanisms (e.g., electrical, thermal) may be preprepared for quick deployment. For example, to quickly apply electrical current, capacitors that may discharge the electrical current may remained charged in case a need for rapid retirement of an edge device is warranted.

Further, any of these mechanisms may be operably connected to a kill switch that will automatically initiate execution of the mechanisms unless the kill switch is reset. Thus, by default, the device may be retired unless the device receives a communication authorizing additional device life. In which, the kill switch may be reset for a future point in time.

As discussed above, the components of FIG. 1 may perform various methods to retire edge devices. FIG. 3 illustrates a method that may be performed by the components of FIG. 1. In the diagram discussed below and shown in FIG. 3, any of the operations may be repeated, performed in different orders, and/or performed in parallel with and/or in a partially overlapping in time manner with other operations.

Turning to FIG. 3, a flow diagram illustrating a method for retiring an edge device in accordance with an embodiment is shown. The method may be performed, for example, by edge management device 100, one or more of edge device 104A-104N, and/or other components of the system of FIG. 1.

At operation 300, a request to retire an edge device of the edge devices may be obtained. The request may be obtained by receiving it from another device, by generating it based on user input, by reading it from storage, and/or via other methods.

At operation 302, a determination may be made regarding whether a burnout procedure is to be performed as a part of retiring the edge device. The determination may be checking the request. The request may specify whether a burnout procedure is to be performed as part of the retirement.

If it is determined that a burnout procedure is to be performed as a part of retiring the edge device, then the method may proceed at operation 304. If it is determined that a burnout procedure is not to be performed as a part of retiring the edge device, then the method may end following operation 302. If the method end following operation 302, it will be appreciated that other activities may be performed to retire the edge device.

At operation 304, the burnout procedure may be performed to eliminate use of a key by the edge device. The burnout procedure may be performed by destroying a trusted platform module that is required for use of the key by the edge device. The trusted platform module may be destroyed by activating an enhanced power circuit that connects a power supply to the trusted platform module and sending a voltage from the power supply to the trusted platform module via the enhanced power circuit to destroy the trusted platform module. The enhanced power circuit may be activated by activating a power management function of a power controller of the edge device and activating a circuitry initiation function of the power supply to initiate use of the enhanced power circuit. The power management function may be activated by receiving a command to activate from the BIOS of the edge device. The circuitry initiation function of the power supply may be activated by receiving a command to activate from the power management function. A voltage may be sent from the power supply to the trusted platform module by receiving a command from the power supply.

The burnout procedure may further be performed by sending an audit report with a set of specifications of the edge device to the edge management device. An audit report may be sent relaying the audit report through communications system 102 to edge management device 100.

The method may end following operation 302 or operation 304.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for retiring edge devices, the method comprising:
obtaining a request to retire an edge device of the edge devices;
making a determination that a burnout procedure is to be performed as part of retiring the edge device; and
based on the determination:
performing the burnout procedure to eliminate use of a key by the edge device, the use of the key being required to use data stored by the edge device.

2. The method of claim 1, wherein performing the burnout procedure comprises:
destroying a trusted platform module that is required for use of the key by the edge device.

3. The method of claim 2, wherein destroying the trusted platform module comprises:
activating an enhanced power circuit that connects a power supply to the trusted platform module;
sending a voltage from the power supply to the trusted platform module via the enhanced power circuit to destroy the trusted platform module, the trusted platform module holding the key.

4. The method of claim 3, wherein performing the burnout procedure further comprises:
sending an audit report with a set of specifications of the edge device to an edge management device, the audit report indicating a condition of the trusted platform module after the voltage is sent to the trusted platform module.

5. The method of claim 4, wherein the set of specifications comprises operating details for the edge device, a location of the edge device, intended results of the burnout procedure, and confirmatory results of a testing procedure which is performed after the burnout procedure and indicates an outcome of the burnout procedure.

6. The method of claim 3, wherein the trusted platform module is powered by the power supply via a second power circuit, the second power circuit sending a second voltage at a level compatible with nominal operation of the trusted platform module, and the voltage being at a higher level than the second voltage to cause the trusted platform module to be damaged by the voltage.

7. The method of claim 3, wherein activating the enhanced power circuit comprises:
activating, by a basic input-output system (BIOS) of the edge device, a power management function of a power controller of the edge device; and
activating, by the power controller and based on the activation by the BIOS, a circuitry initiation function of the power supply to initiate use of the enhanced power circuit.

8. The method of claim 1, wherein the key is a volume management key used to encrypt all data stored by the edge device to obtain encrypted data, and the key being required to decrypt the encrypted data.

9. A non-transitory machine-readable medium having instructions stored therein, which when executed by a processor, cause the processor to perform operations for retiring edge devices, the operation comprising:
obtaining a request to retire an edge device of the edge devices;
making a determination that a burnout procedure is to be performed as part of retiring the edge device; and
based on the determination:
performing the burnout procedure to eliminate use of a key by the edge device, the use of the key being required to use data stored by the edge device.

10. The non-transitory machine-readable medium of claim 9, wherein performing the burnout procedure comprises:
destroying a trusted platform module that is required for use of the key by the edge device.

11. The non-transitory machine-readable medium of claim 10, wherein destroying the trusted platform module comprises:
activating an enhanced power circuit that connects a power supply to the trusted platform module;
sending a voltage from the power supply to the trusted platform module via the enhanced power circuit to destroy the trusted platform module, the trusted platform module holding the key.

12. The non-transitory machine-readable medium of claim 11, wherein performing the burnout procedure further comprises:
sending an audit report with a set of specifications of the edge device to an edge management device, the audit report indicating a condition of the trusted platform module after the voltage is sent to the trusted platform module.

13. The non-transitory machine-readable medium of claim 12, wherein the set of specifications comprises operating details for the edge device, a location of the edge device, intended results of the burnout procedure, and confirmatory results of a testing procedure which is performed after the burnout procedure and indicates an outcome of the burnout procedure.

14. The non-transitory machine-readable medium of claim 11, wherein the trusted platform module is powered by the power supply via a second power circuit, the second power circuit sending a second voltage at a level compatible with nominal operation of the trusted platform module, and the voltage being at a higher level than the second voltage to cause the trusted platform module to be damaged by the voltage.

15. A data processing system, comprising:
a processor; and
a memory coupled to the processor to store instructions, which when executed by the processor, cause the processor to perform operations retiring edge devices, the operations comprising:
obtaining a request to retire an edge device of the edge devices;
making a determination that a burnout procedure is to be performed as part of retiring the edge device; and
based on the determination:
performing the burnout procedure to eliminate use of a key by the edge device, the use of the key being required to use data stored by the edge device.

16. The data processing system of claim 15, wherein performing the burnout procedure comprises:
destroying a trusted platform module that is required for use of the key by the edge device.

17. The data processing system of claim 16, wherein destroying the trusted platform module comprises:
activating an enhanced power circuit that connects a power supply to the trusted platform module;
sending a voltage from the power supply to the trusted platform module via the enhanced power circuit to destroy the trusted platform module, the trusted platform module holding the key.

18. The data processing system of claim 17, wherein performing the burnout procedure further comprises:
sending an audit report with a set of specifications of the edge device to an edge management device, the audit report indicating a condition of the trusted platform module after the voltage is sent to the trusted platform module.

19. The data processing system of claim 18, wherein the set of specifications comprises operating details for the edge device, a location of the edge device, intended results of the burnout procedure, and confirmatory results of a testing procedure which is performed after the burnout procedure and indicates an outcome of the burnout procedure.

20. The data processing system of claim 17, wherein the trusted platform module is powered by the power supply via a second power circuit, the second power circuit sending a second voltage at a level compatible with nominal operation of the trusted platform module, and the voltage being at a higher level than the second voltage to cause the trusted platform module to be damaged by the voltage.
